(19) United States
(12) Patent Application Publication
(10) Pub. No.: US 2017/0342823 A1
(43) Pub. Date: Nov. 30, 2017

(54) PULSE REFLECTION TRAVEL TIME ANALYSIS TO TRACK POSITION OF A DOWNHOLE OBJECT

(71) Applicant: HALLIBURTON ENERGY SERVICES, INC., Houston, TX (US)

(72) Inventors: Vimal V. Shah, Sugarland, TX (US); Neal G. Skinner, Lewisville, TX (US); Chris Gordon, Bakersfield, CA (US)

(73) Assignee: HALLIBURTON ENERGY SERVICES, INC., Houston, TX (US)

(21) Appl. No.: 15/532,057

(22) PCT Filed: Dec. 31, 2014
(86) PCT No.: PCT/US2014/073043

§ 371 Date: May 31, 2017

(51) Int. Cl. E21B 47/09; E21B 33/12; E21B 47/18; G01V 1/50

(52) U.S. Cl. CPC E21B 47/091; G01V 1/50; E21B 33/12; E21B 47/18

(57) ABSTRACT

A method includes deploying an object inside a casing installed in a well, and transmitting a pulse conveyed by fluid in the casing. The method also includes receiving a reflection in response to the pulse, and analyzing a travel time for the reflection determine a position of the object in the well. A related system includes a casing installed in a well, and a pulse transmitter in fluid communication with the casing and configured to transmit pulses via fluid in the casing. The system also includes a receiver in fluid communication with the casing and configured to receive pulse reflections, and a processor in communication with the receiver. The processor analyzes a travel time for at least one pulse reflection to determine a position of an object in the well.

### BACKGROUND

Oil and gas exploration and production generally involves drilling boreholes, where at least some of the boreholes are converted into permanent well installations such as production wells, injection wells, or monitoring wells. Usually, to complete a well installation, a liner or casing is lowered into the borehole and is cemented in place. Further, perforating, running of additional completion equipment, and/or other operations may be performed along the well installation to create different production or injection zones.

During or after the well completion process there are situations where objects such as plugs, darts, balls, or wireline tools are deployed downhole. Depending on the scenario, the target position for an object in a well may vary. Determining when the object is at its target position is important to ensure successful downhole operations involving the object.

As an example scenario, cementing operations often involve deploying one or more plugs inside a casing installed in a well to divide spacer fluid or displacement fluid from cement slurry. In this scenario, the target position for each plug is the casing shoe (the lowest point of the casing section to be cemented). If a plug does not reach the casing shoe, issues such as improper distribution of the cement slurry may occur. Previous efforts to track the position of a plug rely on tracking the volume of fluid being pumped through the casing. However, such tracking does not account for scenarios where fluid volume measurements are inaccurate (e.g., due to fluid escaping the casing or being otherwise diverted from an expected path).

### BRIEF DESCRIPTION OF THE DRAWINGS

Accordingly, there are disclosed in the drawings and the following description methods and systems employing pulse reflection travel time analysis to track position of a downhole object. In the drawings:

FIG. 1 is a schematic diagram showing an illustrative drilling environment.

FIG. 2 is a schematic diagram showing an illustrative downhole object tracking environment.

FIGS. 3A and 3B are schematic diagrams showing illustrative downhole object tracking scenarios.

FIGS. 4A-4C are graphs showing an illustrative initial pulse and reflections.

FIG. 5 is a flowchart showing an illustrative position tracking method for a downhole object.

It should be understood, however, that the specific embodiments given in the drawings and detailed description do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

Disclosed herein are various methods and systems employing pulse reflection travel time analysis to track position of an object deployed downhole. In at least some embodiments, an initial pressure pulse or acoustic pulse is introduced inside a casing installed in a well, where the casing conveys fluids as well as the object. The object causes a reflection of the pulse that can be detected by a pressure or acoustic transducer. The travel time of one or more reflections relative to the initial pulse and/or each other can be analyzed to determine the position of the object. The position of the object identified using pulse reflection travel time analysis may be compared with position information obtained using another technique (e.g., pumped fluid volume analysis). Further, if a determination is made that the downhole object is at its target position, a related operation may be initiated. On the other hand, if a determination is made that the downhole object is not at its target position, further pumping operations may be performed until the object is determined to be at its target position. Further, it may be determined that the object is stuck in an offset position relative to the target position. In such case, operations may be performed to overcome the object's stuck condition. Example operations include increasing the pressure of fluid in the casing, lowering a specialized tool to adjust the casing wall or object dimensions, and/or lowering a specialized tool to “fish” or remove the plug from the casing.

An example method includes deploying an object downhole via a casing installed in a well. The method also includes transmitting a pulse conveyed by fluid in the casing and identifying a reflection in response to the pulse. The method also includes analyzing a travel time of the reflection to determine a position of the object. An example system includes a casing installed in a well. Further, the system includes a pulse transmitter that transmits pulses via fluid in the casing. Further, the system includes a transducer that outputs an electrical signal indicative of a pulse reflection, the pulse reflection caused at least in part by an object deployed downhole via the casing. Further, the system includes a processor that analyses a travel time of the pulse reflection represented by the electrical signal to determine a position of the object. Different pulse options, pulse reflection transducer options, object options, and position use scenarios are described herein.

The disclosed methods and systems are best understood when described in an illustrative usage context. FIG. 1 shows an illustrative drilling environment 10, where a drilling assembly 12 lowers and/or raises a drill string 31 in a borehole 16 that penetrates formations 19 of the earth 18. The drill string 31 is formed, for example, from a modular set of drill pipe joints 32 and adaptors 33. At the lower end of the drill string 31, a bottomhole assembly 34 with a drill bit 38 removes material from the formation 18 using known drilling techniques. The bottomhole assembly 34 also includes one or more drill collars 37 and may include a logging tool 36 to collect measure-while-drilling (MWD) and/or logging-while-drilling (LWD) measurements.

In FIG. 1, an interface 14 at earth's surface receives the MWD and/or LWD measurements via mud based telemetry or other wireless communication techniques (e.g., electromagnetic, acoustic). Additionally or alternatively, a cable (not shown) including electrical and/or optical waveguides (e.g., wires or fibers) may be used to enable transfer of power and/or communications between the bottomhole assembly 34 and earth's surface. Such cables may be integrated with, attached to, or inside components of the drill string 31 (e.g., IntelliPipe® joints may be used).

The interface 14 may perform various operations such as converting signals from one format to another, filtering, demodulation, digitization, and/or other operations. Further, the interface 14 conveys the MWD data, LWD data, and/or data to a computer system 20 for storage, visualization, and/or analysis. Additionally or alternatively, the MWD/LWD data collected at the surface may be transmitted via a wired or wireless network (e.g., phone, cellular radio, cellular phone or satellite) to a remote location for analysis. Further, it should be appreciated that MWD or LWD data may be partly or fully processed by one or more downhole processors (e.g., included with bottomhole assembly 34).

In at least some embodiments, the computer system 20 includes a processing unit 22 that enables visualization and/or analysis of MWD data and/or LWD data by executing software or instructions obtained from a local or remote non-transitory computer-readable medium 28. The computer system 20 also may include input device(s) 26 (e.g., a keyboard, mouse, touchpad, etc.) and output device(s) 24 (e.g., a monitor, printer, etc.). Such input device(s) 26 and/or output device(s) 24 provide a user interface that enables an operator to interact with the logging tool 36 and/or software executed by the processing unit 22. For example, the computer system 20 may enable an operator to select visualization and analysis options, to adjust drilling options, and/or to perform other tasks. Further, the MWD data and/or LWD data collected during drilling operations may facilitate determining the location of subsequent well intervention operations and/or other operations involving deploying an object downhole to a target position along a well. At various times during the drilling process, the drill string 31 shown in FIG. 1 may be removed from the borehole 16. With the drill string 31 removed, well completion or well intervention operations may be performed.

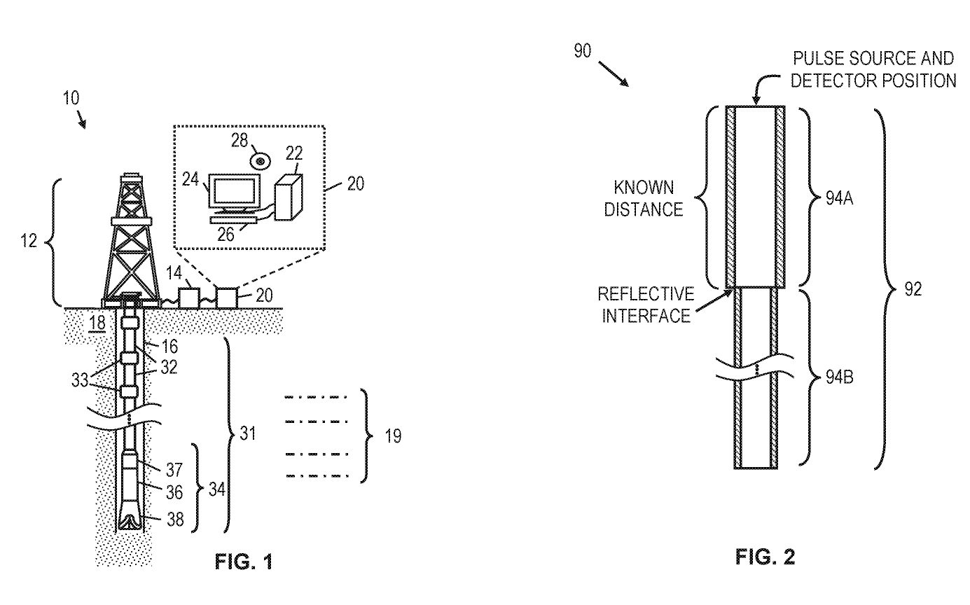

FIG. 2 shows an illustrative downhole object tracking environment 90. In environment 90, a casing 92 with different sections 94A and 94B is represented, where each of the sections 94A and 94B has one or more joints connected by collars. The casing section 94B is shown to have a smaller inner diameter than the casing section 94A. While only two sections 94A and 94B are represented for casing 92, it should be appreciated that casing 92 could include additional sections, where each section may vary with regard to number of joints, inner diameter, outer diameter, collar specifications, joint specifications (e.g., weight, material, length, etc.), and mechanical compliance. In accordance with at least some embodiments, each of the sections 94A and 94B of casing 92 has a different acoustic/pressure propagation velocity due to the fluid within casing 92 as well as the mechanical compliance of each section 94A and 94B.

In the downhole object tracking environment 90, a pulse source and detector position is represented at the top of casing section 94A (e.g., the top casing section). While the positions of the pulse source and the pulse detector may vary, establishing known positions relative to each other and to any reflective interfaces along the casing 92 are helpful to interpret reflection travel time data. For example, the junction between casing sections 94A and 94B may correspond to a reflective interface due to, at least in part, the inner diameter of section 94B being smaller than the inner diameter of section 94A. Assuming the length of section 94A is known, the distance between the pulse source/detector position and the reflective interface is also known. Accordingly, the propagation speed of pulses and pulse reflections conveyed by fluid within casing 92 can be determined based on reflection travel time and the known position of the reflective interface. The propagation speed of pulses in a fluid determined using a known reflective interface relative to the pulse source/detector position can be used later for pulse reflection travel time analysis to determine the unknown or changing position of a downhole object as described herein.

As desired, one or more reflective interfaces with a known position can be added to casing 92 to enable the propagation speed of pulses to be determined. Example reflective interfaces may be due to variance in inner diameter as shown and/or due to variance in mechanical compliance. Additionally or alternatively, the fluid conveyed within the casing 92 could have known pulse propagation speed properties. For example, the fluid within the casing 92 may be predetermined or sampled. Once the fluid within the casing 92 is identified, its known pulse propagation speed properties can be used for pulse reflection travel time analysis. In such case, the step of testing the pulse propagation speed using a reflective interface with a known position relative to the pulse source/detector position can be omitted, or may serve other purposes such as to estimate the mechanical compliance of a casing section. While FIG. 2 illustrates a reflective interface formed by a decrease in inner diameter along casing 92, it should be appreciated that an increase in inner diameter along casing 92 may alternatively serve as a suitable reflective interface. Further, in alternative embodiments, a short joint section or collar that varies with regard to inner diameter or mechanical compliance may be sufficient to form a suitable reflective interface at a known position.

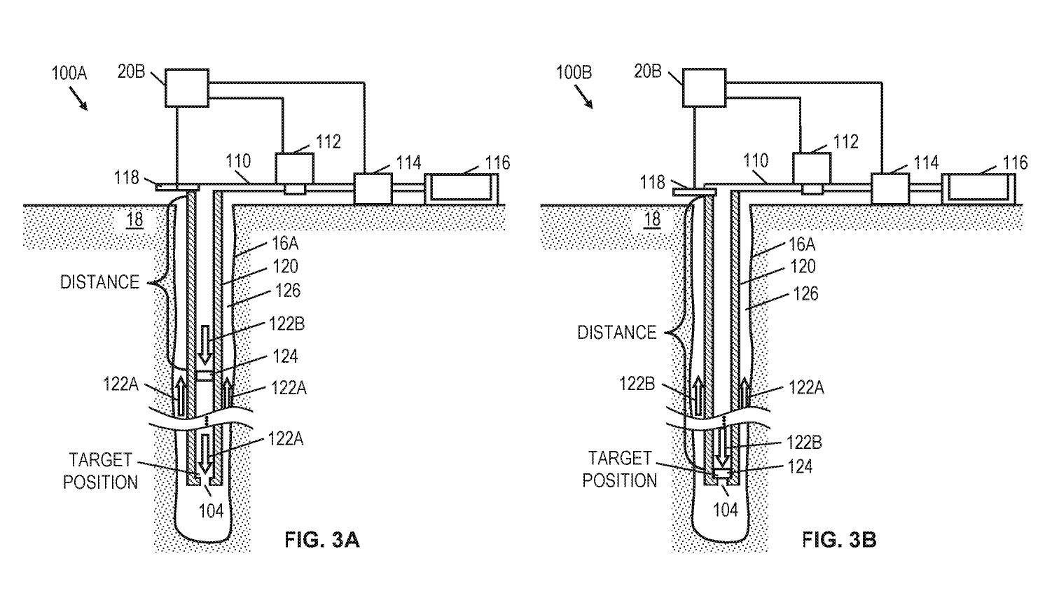

FIGS. 3A and 3B shows illustrative downhole object tracking scenarios 100A and 100B involving pulse reflection travel time analysis. In scenario 100A, object 124 is in an offset position relative to its target position. Meanwhile, in scenario 100B, object 124 has reached its target position. In both scenarios 100A and 100B, a borehole 16A has been formed in the earth 18, and a casing 120 has been lowered into place, but has not yet been cemented. In different object tracking scenarios, the object 124 may alternatively represent a plug, dart, or ball used to separate fluids and/or to control flow at a target position in the well. For example, the object 124 may correspond to a plug that separates a first fluid 122A from a second fluid 122B. The fluids 122A and 122B may correspond to any of a drilling mud, a cleansing fluid, a cement slurry, a spacer or displacement fluid, a treatment fluid, etc.

In at least some embodiments, fluid 122A is pumped through the casing 120 using a pump 114 in fluid communication with one or more fluid tanks or reservoirs 116. For example, the operation of the pump 114 may cause fluid 122A to be drawn from a corresponding fluid tank 116 and moved through conduit 110 to the interior of casing 120. Eventually, the fluid 122A passes through a fluid channel 104 at the bottom of casing 120 and is directed upward in an annular space 126 between an exterior surface of casing 120 and the borehole wall. Depending on the particular scenario, pumping continues at least until the object 124 reaches its target position. Depending on the particular function of object 124, further pumping may or may not be performed. Further, in some embodiments, the object 124 may be configured to break or otherwise expose the fluid channel 104 (e.g., in response to sufficient pressure) at the bottom of casing 120 as desired.

To track the position of the object 124 based on pulse reflection travel time analysis, two additional components are needed. One of the components needed is a pulser 112 in fluid communication with an interior of the casing 120. For example, in scenarios 100A and 100B, the pulser 112 is positioned along the conduit 110 between the pump 114 and the casing 120. Alternatively, the pulser 112 may be positioned at or near the top of casing 120 using a specialized casing joint or collar. In different embodiments, the pulser 112 may correspond to a pressure pulser or an acoustic pulser. A suitable pulser is commercially available from Halliburton under the Geo-Span® downlink service. One example pulser 112 corresponds to a valve along the conduit 110 that rapidly pinches and releases the fluid flow. Another example pulser 112 corresponds to an empty air chamber and a fast acting valve, where pressurized fluid from the conduit 112 is quickly dumped by the fast acting valve. Another example pulser 112 corresponds to a pressurized chamber, where a pressurized charge of fluid is injected by a fast acting valve.

The other component needed to track position of the object 124 based on pulse reflection travel time analysis is a transducer 118 capable of converting a pulse reflection into an electrical signal. In the event that pulser 112 is an acoustic pulser, the transducer 118 corresponds to an acoustic transducer that responds to acoustic variations by outputting a corresponding voltage or current. It should be appreciated that acoustic transducers may vary with respect to their sensitivity to particular frequency bands. Further, different gain or amplifier arrangements may be provided for different acoustic transducers. Further, in at least some embodiments, different types of acoustic transducers may be employed. Example acoustic transducers include, but are not limited to, microphones, hydrophones, and sound intensity probes. Some of the components used for acoustic transducers (to convert sound waves to electrical signals) include magnets, electromagnets, piezoelectric elements, micro-electro-mechanical (MEMS) elements, electrostrictive elements, magnetostrictive elements, ceramic elements, and flexible membranes.

In the event that pulser 112 is a pressure pulser, the transducer 118 corresponds to a pressure transducer that responds to pressure variations by outputting a corresponding voltage or current. In at least some embodiments, an example pressure transducer configuration employs a piezoelectric material attached to or surrounding the conduit 110, the casing 120, or another conduit in fluid communication with the casing 120. When the pressure of fluid conveyed via the casing 120 or a conduit changes, the piezoelectric material is distorted resulting in a different voltage level between two measurement points along the piezoelectric material. Another pressure transducer configuration employs an optical fiber wrapped around the casing 120, conduit 110, or another conduit in fluid communication with the casing 120.

When the pressure of fluid conveyed via the casing 120 or a conduit changes, the dimensions of the casing 120 or the conduit changes resulting in the wrapped optical fiber being more or less strained (i.e., the overall length of the optical fiber is affected). The amount of strain or change to the optical fiber length can be measured (e.g., using interferometry to detect a phase change) and correlated with the pressure of fluid conveyed via the casing 120 or conduit. It should also be appreciated that multiple pressure transducers may be employed at different points along the casing 120 or a conduit in fluid communication with the casing 120. The outputs from multiple pressure transducers may be averaged or otherwise combined. For more information regarding available pressure transducer configurations, reference may be had to U.S. Pat. Pub. No. 2011/0116099A1, entitled “Apparatus and Method for Detecting Pressure Signals” and filed Mar. 16, 2008, and WO2014/025701 A1, entitled “Differential Pressure Mud Pulse Telemetry While Pumping” and filed Aug. 5, 2013.

As pressure variations of fluid in the casing 120 is a function of the operation of the pump 114, at least some embodiments account for “pump noise” such that pulse reflections corresponding to the pulser 112 are distinguishable from pressure variations due to pump noise. To account for pump noise, fluid pressure variations due to the operations of the pump 114 are indentified by tracking pump strokes or otherwise tracking the mechanical movements of the pump 114 that are related to the pressure of fluid in the casing 120. Once the pump noise is accounted for, identifying pulse reflections caused by the operations of the pulser 112 and downhole object 124 is facilitated. A similar process is performed when demodulating a mud pulse telemetry (MPT) data stream. Thus, filtering techniques used for MPT demodulation can be applied for pulse reflection travel time analysis.

By strategically positioning the transducer 118 relative to the casing 120, the initial pulse and pulse reflections can be detected and reflection travel time analysis performed. In at least some embodiments, the transducer 118 is positioned near the top (surface) end of the casing 120 to minimize the number of signals to be interpreted. Even if the transducer 118 were to be positioned some distance between the top of the casing 120 and the downhole object 124, reflection travel time analysis can determine the position of the object 124 relative to the transducer 118 (assuming the position of the transducer 118 relative to the object 124 and any reflection points are known or ascertainable).

The electrical signal output from the transducer 118 is digitized and forwarded to a computer 20B, where travel time analysis of pulse reflections is performed to determine a position of the object 124. Further, the computer 20B or another controller in communication with the computer 20B is coupled to the pulser 112 and the pump 114. As needed, the operations of the pulser 112 and the pump 114 are directed based on the position of the object 124 determined by the computer 20B. Further, a monitor associated with computer 20B may display position information or alerts (e.g., a stuck condition or target reached condition) based on travel time analysis of pulse reflections.

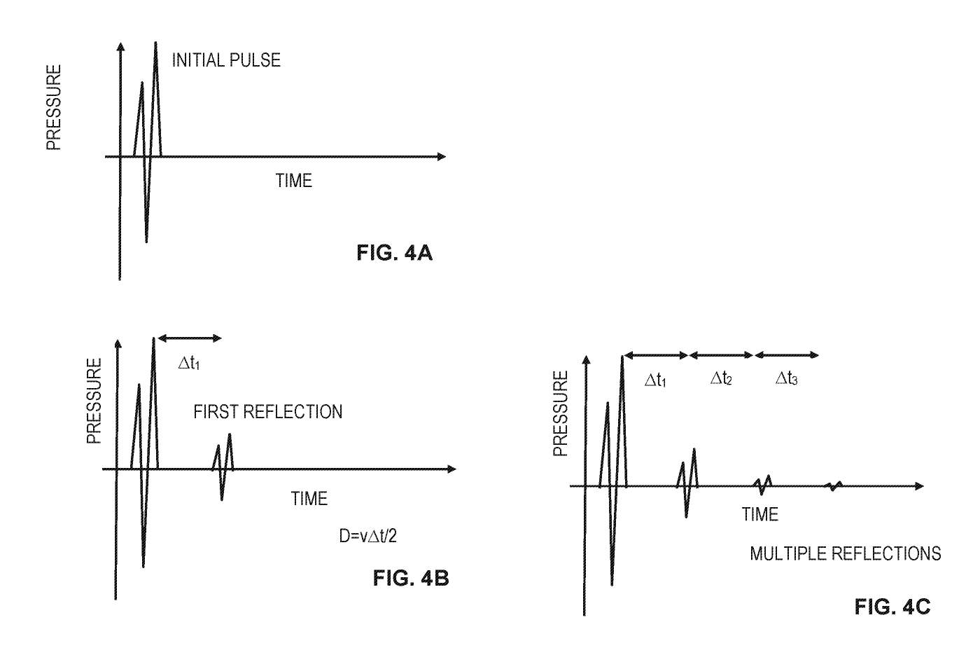

FIGS. 4A-4C are graphs showing an illustrative initial pulse and reflections. In FIG. 4A, an initial pressure pulse is shown to vary as a function of time. In response to an initial pressure pulse, the transducer 118 would output a corresponding electrical signal. In FIG. 4B, the initial pressure pulse and a first reflection are represented. The travel time (Δt₂) between the initial pulse and the first reflection can be correlated with the total distance traversed by the pressure pulse and reflection relative to the transducer 118. In at least some embodiments, the distance between the object 124 and the transducer 118 is calculated as D=vΔt₁/2, where v is the velocity of a pressure signal through the fluid in the casing 120. It should be appreciated that v will vary depending on the particular fluid present within the casing 120 and the mechanical compliance of the casing. In FIG. 4C, the initial pulse and multiple reflections are represented. The travel time (Δt₂) between the initial pulse and the first reflection can be correlated with the total distance traversed by the pressure pulse and reflection relative to the transducer 118. The pulse does not stop after one round trip (e.g., it may reflect from the top of the casing/equipment near earth's surface) and may make one or more additional round trips between the surface and the top plug. This will result in a series of pulses being recorded by the transducer 118 resulting from the single pulse emitted by the pulser 112. The travel times (Δt₂, Δt₃) between each subsequent reflection can be correlated with the total distance traversed by the pressure pulse and reflection relative to the transducer 118. Note that the amplitudes of the multiple reflections decrease as each reflection represents a “round trip” between the sensor and the reflecting object. Since acoustic pulses experience losses as they propagate, this decrease in amplitude should be expected.

For example, if Δt₁=Δt₂=Δt₃, the distance between the object 124 and the transducer 118 can be determined and is fixed. If the fixed distance corresponds to the target position, subsequent operations may be based on the determination that the object 124 is at the target position. If the fixed distance corresponds to an offset position relative to the target position, subsequent operations may be based on the determination that the object 124 is stuck at the offset position relative to the target position. Meanwhile, if Δt₁<Δt₂<Δt₃, the distance between the object 124 and the transducer 118 can be determined for each Δt (for Δt₁<Δt₂<Δt₃, the distance is increasing as a function of time). Subsequent operations may be based on where the object 124 is relative to the target position. While FIGS. 4A-4C represent a single pulse from the surface and corresponding reflections, it should be appreciated that multiple pulses carried out over time may be used to verify or track the position of the object 124. Further, it is possible to employ multiple pulsers and multiple transducers to provide a desired level of redundancy and/or to account for variations in how the position of a particular pulser or transducer affects the pulse reflection travel time analysis.

Note in FIGS. 4A through 4C that all the reflections are positive. This is most easily seen in FIG. 4B where schematically, the initial pulse increases, decreases to a negative value, increases to a positive value and decreases to zero. The general trend of pressure changes in the first reflection is identical to the initial pulse.

In general, this may not be the case, depending on the change of acoustic impedance between the fluid and the reflecting object, the reflection may be either positive or negative. If the reflection in FIG. 3B was negative, the first reflection would decrease to a negative value, increase to a positive value decrease to a lower negative value and increase to zero. Since the technique described here only depends on the arrival times of the reflections and not on the sign of the reflection, it is immaterial whether the received reflections are positive or negative.

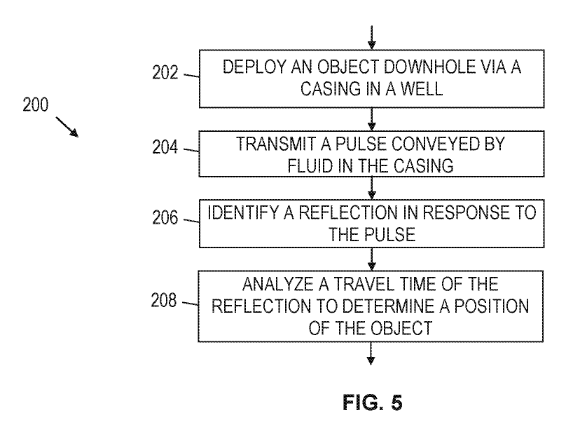

FIG. 5 shows a method 200 for pulse reflection travel time analysis to track position of a downhole object. As shown, the method 200 includes deploying an object downhole via a casing in a well (block 202). The object deployed downhole may correspond to a plug, ball, dart, or downhole tool. In some scenarios, a wireline or coiled tubing is used to deploy and retrieve the object. Alternatively, the object may be deployed downhole without a retrieval plan (e.g., the object may be broken or otherwise removed from a fluid flow path without it being retrieved). At block 204, a transmitted pulse is conveyed by fluid in the casing. The transmitted pulse may correspond to an acoustic pulse or pressure pulse. At block 206, a reflection in response to the pulse is identified, where the reflection is due to the downhole object. At block 208, a travel time of the reflection is analyzed to determine a position of the object. As desired, the position of the object obtained from travel time analysis of a pulse reflection may be compared to a reference position or target position. For example, the reference position may correspond to another estimate of the downhole object's position based on a different position tracking technique (e.g., fluid volume tracking). The target position may correspond to the bottom of a casing section to be cemented, or to some point along a casing where well intervention operations are to be performed. As described herein, multiple reflections may be analyzed to track position of the downhole object as a function of time. If a stuck condition is identified, operations may be performed to release the object from its stuck condition (e.g., adjusting a casing diameter or casing anomaly). Once the downhole object is determined to have reached its target position, subsequent operations are performed. Example operations involve breaking or otherwise enable fluid flow through the downhole object (as is the case with a bottom plug), cleaning a casing's exterior in preparation for cementing, pumping a volume of cement slurry, performing a well intervention, etc.

Embodiments disclosed herein include:

A: A method that comprises deploying an object downhole via a casing installed in a well, and transmitting a pulse conveyed by fluid in the casing. The method also comprises identifying a reflection in response to the pulse, and analyzing a travel time of the reflection to determine a position of the object.

B: A system that comprises a casing installed in a well. The system also comprises a pulse transmitter that transmits pulses via fluid in the casing. The system also comprises a transducer that outputs an electrical signal indicative of a pulse reflection, the pulse reflection caused at least in part by an object deployed downhole via the casing. The system also comprises a processor that analyses a travel time of the pulse reflection represented by the electrical signal to determine a position of the object.

Each of the embodiments, A and B, may have one or more of the following additional elements in any combination. Element 1: further comprising analyzing the travel time of multiple reflections in response to at least one pulse to determine the position of the object in the well as a function of time. Element 2: wherein the object separates drilling mud and cleansing fluid being pumped through the casing. Element 3: wherein the object separates spacer fluid or displacement fluid from cement slurry being pumped through the casing. Element 4: further comprising determining a pulse propagation speed prior to analyzing the travel time of the reflection. Element 5: wherein determining the pulse propagation speed comprises identifying a reflection due to at least one reflective interface with a known position along the casing. Element 6: wherein determining the pulse propagation speed comprises identifying the fluid and assigning a pulse propagation speed based on the identified fluid. Element 7: further comprising comparing the determined position of the object in the well with a target position. Element 8: further comprising comparing the determined position of the object in the well with a reference position that is based on a volume of fluid pumped, and identifying an amount of diverted fluid based on said comparing. Element 9: further comprising identifying the object as being stuck in an offset position relative to a target position based on the determined position and a pressure response of the fluid in the casing. Element 10: wherein the at least one pulse corresponds to at least one pressure pulse. Element 11: wherein the at least one pulse corresponds to at least one acoustic pulse.

Element 12: wherein the processor further analyzes the travel time of multiple pulse reflections to determine the position of the object in the well as a function of time. Element 13: wherein the object corresponds to a bottom plug, a top plug, a ball, or a dart. Element 14: wherein the processor analyzed the travel time of the pulse reflection based using a predetermined pulse propagation speed. Element 15: wherein the processor compares the determined position of the object in the well with a reference position that is based on a volume of fluid pumped, and wherein the processor identifies an amount of diverted fluid based on the comparison. Element 16: wherein processor identifies the object as being stuck in an offset position relative to a target position based on the determined position and a pressure response of the fluid in the casing. Element 17: further comprising a monitor in communication with the processor, wherein the monitor displays a representation of the object's position in the well as a function of time and related alerts. Element 18: wherein the at least one pulse transmitter transmits pressure pulses or acoustic pulses.

Numerous variations and modifications will become apparent to those skilled in the art once the above disclosure is fully appreciated. For example, in at least some embodiments, the operations described herein may be associated with one or more operator interfaces. In such case, the position information determined from pulse reflection travel time analysis as described herein may be related to information or instructions displayed via an operator interface to enable one or more operators to manually control available operations. A suitable operator interface enables an operator to review and select available operations once a downhole tool reaches its target position or is determined to be in a struck condition. Alternatively, the position information determined from pulse reflection travel time analysis as described herein may be related to control signals conveyed directly to control components (e.g., wireline assembly 50, pump assembly 64, a downhole tool) to enable automated operations. It is intended that the following claims be interpreted to embrace all such variations and modifications.

What is claimed is:

1. A method that comprises:
deploying an object downhole via a casing installed in a well;
transmitting a pulse conveyed by fluid in the casing;
identifying a reflection in response to the pulse; and
analyzing a travel time of the reflection to determine a position of the object.

2. The method of claim 1, further comprising analyzing the travel time of multiple reflections in response to at least one pulse to determine the position of the object in the well as a function of time.

3. The method of claim 1, wherein the object separates drilling mud and cleansing fluid being pumped through the casing.

4. The method of claim 1, wherein the object separates spacer fluid or displacement fluid from cement slurry being pumped through the casing.

5. The method of claim 1, further comprising determining a pulse propagation speed prior to said analyzing.

6. The method of claim 5, wherein said determining the pulse propagation speed comprises identifying a reflection due to at least one reflective interface with a known position along the casing.

7. The method of claim 5, wherein said determining the pulse propagation speed comprises identifying the fluid and assigning a pulse propagation speed based on the identified fluid.

8. The method of claim 1, further comprising comparing the determined position of the object in the well with a target position.

9. The method of claim 1, further comprising comparing the determined position of the object in the well with a reference position that is based on a volume of fluid pumped, and identifying an amount of diverted fluid based on said comparing.

10. The method of claim 1, further comprising identifying the object as being stuck in an offset position relative to a target position based on the determined position and a pressure response of the fluid in the casing.

11. The method of claim 1, wherein the at least one pulse corresponds to at least one pressure pulse.

12. The method of claim 1, wherein the at least one pulse corresponds to at least one acoustic pulse.

13. A system that comprises:
a casing installed in a well;
a pulse transmitter that transmits pulses via fluid in the casing;
a transducer that outputs an electrical signal indicative of a pulse reflection, the pulse reflection caused at least in part by an object deployed downhole via the casing; and
a processor that analyses a travel time of the pulse reflection represented by the electrical signal to determine a position of the object.

14. The system of claim 13, wherein the processor further analyzes the travel time of multiple pulse reflections to determine the position of the object in the well as a function of time.

15. The system of claim 13, wherein the object corresponds to a bottom plug, a top plug, a ball, or a dart.

16. The system of claim 13, wherein the processor analyzed the travel time of the pulse reflection based using a predetermined pulse propagation speed.

17. The system of claim 13, wherein the processor compares the determined position of the object in the well with a reference position that is based on a volume of fluid pumped, and wherein the processor identifies an amount of diverted fluid based on the comparison.

18. The system of claim 13, wherein processor identifies the object as being stuck in an offset position relative to a target position based on the determined position and a pressure response of the fluid in the casing.

19. The system of claim 13, further comprising a monitor in communication with the processor, wherein the monitor displays a representation of the object's position in the well as a function of time and related alerts.

20. The system of claim 13, wherein the at least one pulse transmitter transmits pressure pulses or acoustic pulses.
